(19) United States
(12) Patent Application Publication
(10) Pub. No.: US 2026/0061873 A1
(43) Pub. Date: Mar. 5, 2026

(54) DYNAMIC POWER SHARING ELECTRIC VEHICLE SUPPLY EQUIPMENT AVAILABILITY DETECTION SYSTEM

(71) Applicant: HERE GLOBAL B.V., EINDHOVEN (NL)

(72) Inventors: LAURI AARNE JOHANNES WIROLA, TAMPERE (FI); MIKA AHTI PETTERI VIITALA, TAMPERE (FI)

(73) Assignee: HERE GLOBAL B.V., EINDHOVEN (NL)

(21) Appl. No.: 18/822,326

(22) Filed: Sep. 2, 2024

(51) Int. Cl. B60L 53/62; B60L 53/63; B60L 53/66; G01C 21/36

(52) U.S. Cl. CPC B60L 53/62; B60L 53/63; B60L 53/66; G01C 21/3679

(57) ABSTRACT

A system, method, apparatus, etc., for electric vehicle supply equipment management wherein an indication of at least a first location of an electric vehicle and its charging needs are obtained along with charge point data for vehicle chargers proximate to the location of the electric vehicle. Based on this and other data, a dynamic power sharing availability indicator may be determined with this indicator used in map databases, automated vehicle routing, etc.

### TECHNOLOGICAL FIELD

An example embodiment relates generally to a method, apparatus, computer readable storage medium, user interface and/or computer program product for charging an electric vehicle (EV) at one or more charging points, and more particularly, predicting and identifying electric vehicle supply equipment (EVSE) with dynamic power sharing (DPS) for optimizing charging one or more EVs.

### BACKGROUND

Electric vehicle (EV) adoption has become widespread and is predicted to continue to grow strongly in the upcoming years. EVs are generally efficient and emit fewer emissions while driving when compared to traditional vehicles with internal combustion engines (ICEs). However, the EV charging infrastructure available in most countries substantially lags compared to the petroleum fuel infrastructure and is struggling to keep pace with the EV adoption rate.

In some cases, the charging infrastructure features EV charging stations that have too few charging points for which there is too much demand. Other issues include broken chargers, high rates (cost), and confusion about how to pay as well as how long is needed to charge an EV. Moreover, there are multiple connector types and multiple charging speeds for some charging points. Yet another issue is that only certain electric vehicle supply equipment (EVSE, also know as charge points, chargers, charge cords, plugs, etc.) are capable of dynamic power sharing.

### BRIEF SUMMARY

A method, apparatus, computer readable storage medium, user interface, and computer program product are provided in accordance with an example embodiment to determine and predict the probability a given EVSE will have dynamic power sharing capabilities and if a given end user will interact with this EVSE.

In this regard, the method, apparatus, computer readable storage medium, and computer program product of an example embodiment may be an apparatus, the apparatus comprising at least one processor and at least one memory storing computer program code, the at least one memory and the computer program code configured to, with the processor, cause the apparatus to at least: obtain an indication of at least a first location of an electric vehicle and charging need data of the electric vehicle; obtain charging data for one or more electric vehicle charge points proximate to the first location of the electric vehicle; determine a dynamic power sharing availability indicator based, at least in part, on the charging need data of the electric vehicle and a predicted arrival time for the electric vehicle at the one or more electric vehicle charge points proximate to the first location of the electric vehicle; and update at least one database record with the determined dynamic power sharing indicator. In some embodiments, the first location of an end user device is captured by a combination of GNSS data and vehicle sensor data.

In other embodiments, the dynamic power sharing availability indicator is determined at least in part on a preset battery charge level of one or more of the more electric vehicles utilizing one charge point proximate to the first location of the electric vehicle. The dynamic power sharing availability indicator may also be determined at least in part on an EV charging curve of one or more of the more electric vehicles utilizing one charge point proximate to the first location of the electric vehicle. The dynamic power sharing availability indicator may also be determined at least in part on the max nominal charging power of one or more of the more electric vehicle charge points proximate to the first location of the electric vehicle. The dynamic power sharing availability indicator may yet also be determined at least in part on the instantaneously available charging power of one or more of the more electric vehicle charge points proximate to the first location of the electric vehicle. The determined dynamic power sharing availability indicator may also be determined at least in part on real-time data from a charge point operator. The determined dynamic power sharing availability indicator may also be used to initiate an automated vehicle control signal.

In yet other embodiments, the determined dynamic power sharing availability indicator is used to route one or more electric vehicles to an electric vehicle charge point. The routing data for at least two electric vehicles may also be used to update a dynamic power sharing availability indicator. The routing data for various EV may also be updated based on a availability indicator for a given charge point.

All this information/feedback may be displayed on an end user device (e.g., smartphone, tablet, etc.) and/or in a motor vehicle (e.g., upon a built-in vehicle display).

In other embodiments, a UI may be provided which displays in real-time the payment credentials to be used in a list format or as another visual element of the UI. Users may also manually select the credentials, etc. from this list.

Also, a computer program product may be provided. For example, a computer program product comprising instructions which, when the program is executed by a computer, cause the computer to carry out the steps described herein.

In yet another aspect, disclosed is an apparatus and/or non-transitory computer readable medium having stored thereon instructions executable by processor(s) to cause an apparatus to perform operations described herein, such as any of those set forth in the disclosed method(s), among others.

In yet another aspect, disclosed is a computer program product including instructions which, when the program is executed by a computer, cause the computer to carry out the steps described herein, such as any of those set forth in the disclosed method(s). In other words, the computer program product may have computer-executable program code portions stored therein, the computer-executable program code portions including program code instructions configured to perform any operations set forth in any of the method(s) disclosed herein, among others.

These as well as other features and advantages of the invention will become apparent from the following detailed description considered in conjunction with the accompanying drawings where appropriate. It should be understood, however, that the drawings are designed solely for the purposes of illustration and not as a definition of the limits of the present disclosure. It should be further understood that the drawings are not drawn to scale and that they are merely intended to conceptually illustrate one or more of the features described herein. None of the examples shown or discussed herein are limiting on any aspect of the claimed subject matter.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment;

FIG. 2 is a block diagram of a geographic database of an example embodiment of the apparatus;

FIG. 3A is a flowchart illustrating the operations performed, such as by the apparatus of FIG. 1, in order for an apparatus;

FIG. 3B is a flowchart illustrating the operations performed, such as by the apparatus of FIG. 1, in order to provide a graphical user interface and/or functions thereof;

FIG. 3C is a flowchart illustrating the operations performed, such as by the apparatus of FIG. 1, in order to train machine learning models;

FIG. 4A is a graphical representation of an end user exiting their home and

approaching their vehicle while using the apparatus;

FIG. 4B is a graphical representation of a road upon which a passenger car is present and the apparatus is in use;

FIG. 5 is a graphical representation of a parking lot within which the apparatus is in use.

FIG. 6 is a diagram of power sharing schemes for two charge points.

### DETAILED DESCRIPTION

Some embodiments of the present invention will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A system, method, apparatus, user interface, and computer program product are provided as example embodiments to provide a dynamic power sharing EVSE detection system based on various data sources. In order to provide such a service, the system, method, apparatus, non-transitory computer-readable storage medium, and computer program product of an example embodiment may be configured to obtain an indication of at least a first location of an end user or vehicle, obtain an indication of at least a first location of an electric vehicle, obtain charging data for one or more electric vehicle charge points proximate to the first location of the electric vehicle, determine a dynamic power sharing availability indicator based, at least in part, on electric vehicle charging needs and a predicted arrival time for the electric vehicle at the one or more electric vehicle charge points proximate to the first location of the electric vehicle, and update at least one database record with the determined dynamic power sharing indicator.

The system, apparatus, method, etc. described above may be any of a wide variety of computing devices and may be embodied by either the same or different computing devices. The system, apparatus, etc. may be embodied by a server, a computer workstation, a distributed network of computing devices, a personal computer or any other type of computing device. The system, apparatus, etc. configured to detect and predict appointment attendance may similarly be embodied by the same or different server, computer workstation, distributed network of computing devices, personal computer, or other type of computing device.

Alternatively, the system, etc. may be embodied by a computing device on board a vehicle, such as a computer system of a vehicle, e.g., a computing device of a vehicle that supports safety-critical systems such as the powertrain (engine, transmission, electric drive motors, etc.), steering (e.g., steering assist or steer-by-wire), and/or braking (e.g., brake assist or brake-by-wire), a navigation system of a vehicle, a control system of a vehicle including but not limited to various automated vehicle controls, an electronic control unit of a vehicle, an autonomous vehicle control system (e.g., a semi or fully autonomous-driving control system) of a vehicle, a mapping system of a vehicle, an Advanced Driver Assistance System (ADAS) of a vehicle), or any other type of computing device carried by the vehicle. Still further, the apparatus may be embodied by a computing device of a driver or passenger on board the vehicle, such as a mobile terminal, e.g., a personal digital assistant (PDA), mobile telephone, smart phone, personal navigation device, smart watch, tablet computer, or any combination of the aforementioned and other types of portable computer devices.

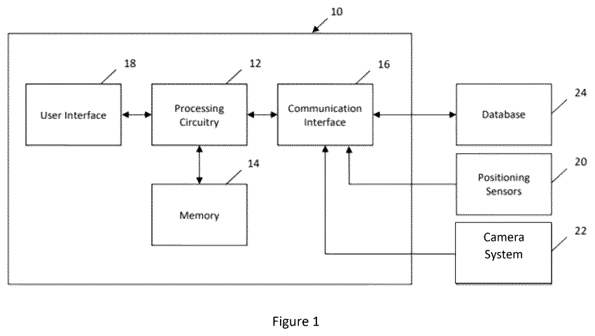

Regardless of the manner in which the system, apparatus, etc. is embodied, however, an apparatus 10 includes, is associated with, or is in communication with processing circuitry 12, memory 14, a communication interface 16 and optionally a user interface 18 as shown in FIG. 1. In some embodiments, the processing circuitry (and/or co-processors or any other processors assisting or otherwise associated with the processing circuitry) can be in communication with the memory via a bus for passing information among components of the apparatus. The memory can be non-transitory and can include, for example, one or more volatile and/or non-volatile memories. In other words, for example, the memory may be an electronic storage device (for example, a computer readable storage medium) comprising gates configured to store data (for example, bits) that can be retrievable by a machine (for example, a computing device like the processing circuitry). The memory can be configured to store information, data, content, applications, instructions, or the like for enabling the apparatus to carry out various functions in accordance with an example embodiment of the present disclosure. For example, the memory can be configured to buffer input data for processing by the processing circuitry. Additionally, or alternatively, the memory can be configured to store instructions for execution by the processing circuitry.

The processing circuitry 12 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry can include one or more processing cores configured to perform independently. A multi-core processor can enable multiprocessing within a single physical package. Additionally, or alternatively, the processing circuitry can include one or more processors configured in tandem via the bus to enable independent execution of instructions, pipelining and/or multithreading.

In an example embodiment, the processing circuitry 12 can be configured to execute instructions stored in the memory 14 or otherwise accessible to the processing circuitry. Alternatively, or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 10 of an example embodiment can also include the communication interface 16 that can be any means such as a device or circuitry embodied in either hardware or a combination of hardware and software that is configured to receive and/or transmit data from/to other electronic devices in communication with the apparatus, such as a database 24 which, in one embodiment, comprises a map database that stores data (e.g., one or more map objects, POI data, etc.) generated and/or employed by the processing circuitry 12. Additionally, or alternatively, the communication interface can be configured to communicate in accordance with various wireless protocols including Global System for Mobile Communications (GSM), such as but not limited to Long Term Evolution (LTE), 3G, 4G, 5G, 6G, etc. In this regard, the communication interface can include, for example, an antenna (or multiple antennas) and supporting hardware and/or software for enabling communications with a wireless communication network. In this regard, the communication interface can include, for example, an antenna (or multiple antennas) and supporting hardware and/or software for enabling communications with a wireless communication network. Additionally, or alternatively, the communication interface can include the circuitry for interacting with the antenna(s) to cause transmission of signals via the antenna(s) or to handle receipt of signals received via the antenna(s). In some environments, the communication interface can alternatively or also support wired communication and/or may alternatively support vehicle to vehicle or vehicle to infrastructure wireless links. The communication mediums may also be used to aid in position of a given end user, vehicle, and/or mobile device.

In certain embodiments, the apparatus 10 can be equipped or associated with one or more positioning sensors 20, such as one or more GPS or GNSS sensors, one or more accelerometer sensors, one or more light detection and ranging (LiDAR) sensors, one or more radar sensors, one or more gyroscope sensors, and/or one or more other sensors. Any of the one or more sensors may be used to sense information regarding movement, positioning and location, and/or orientation of the apparatus for use, such as by the processing circuitry 12, in navigation assistance and/or autonomous vehicle control, as described herein according to example embodiments.

In certain embodiments, the apparatus 10 may further be equipped with or in communication with one or more camera systems 22. In some example embodiments, the one or more camera systems 22 can be implemented in a vehicle or other remote apparatuses. The camera systems 22 may include systems which capture both image data and audio data (via a microphone, etc.).

For example, the one or more camera systems 22 can be located upon a vehicle or proximate to it (e.g., traffic cameras, security cameras, etc.). While embodiments may be implemented with a single camera such as a front facing camera in a consumer vehicle, other embodiments may include the use of multiple individual cameras at the same time. A helpful example is that of a consumer sedan driving down a road. Many modern cars have one or more cameras installed upon them to enable automatic braking and other types of assisted or automated driving. Many cars also have rear facing cameras to assist with automated or manual parking. In one embodiment of the current system, apparatus, method, etc. these cameras are utilized to capture images and/or audio of end users, vehicles, streets, etc. as an end user travels/moves around. The system, apparatus, etc. takes these captured images and/or audio (via the camera systems 22) and analyzes them along with other relevant data to determine a location of an end user on a certain street, area, etc. Images of end user communications may also be captured in some embodiments. It should be noted that various types of data such as end user location data and battery/charge data may be detected via any functional means.

The data captured concerning an end user's location may also come from traffic cameras, security cameras, or any other functionally useful source (e.g., historic data, satellite images, websites, NFC data, Wi-Fi positioning, etc.).

The analysis of the image data, audio data, and other relevant data concerning end user communications, location, etc. may be carried out by a machine learning model. This model may utilize any functionally useful means of analysis to identify end user location on a given roadway, road segment, building, or in a general area. The system, in this embodiment, may also examine relevant proximate points of interest (POIs), map objects, road geometries, animate objects, etc. which could suggest potential end user location information.

The locations of an end user, their vehicle, any relevant points of interest (POIs), and other types of data which are utilized by various embodiments of the apparatus may each be identified in latitude and longitude based on a location of the end user and their vehicle using a sensor, such as a GPS sensor to identify the location of the end user's device (e.g., smart phone, smart watch, tablet, etc.) and/or the end user vehicle. The POIs, map objects, infrastructure, etc. identified by the system may also be detected via the camera systems 22.

In certain embodiments, information detected by the one or more cameras or other sensors may be transmitted to the apparatus 10, such as the processing circuitry 12, as image data and/or audio data. The data transmitted by the one or more cameras, microphones, etc. can be transmitted via one or more wired communications and/or one or more wireless communications (e.g., near field communication, or the like). In some environments, the communication interface 16 can support wired communication and/or wireless communication with the one or more system sensors (e.g., cameras, etc).

The apparatus 10 may also optionally include a user interface 18 that may, in turn, be in communication with the processing circuitry 12 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processing circuitry may comprise user interface circuitry configured to control at least some functions of one or more user interface elements such as a display and, in some embodiments, a plurality of speakers, a ringer, one or more microphones and/or the like. The processing circuitry and/or user interface circuitry embodied by the processing circuitry may be configured to control one or more functions of one or more user interface elements through computer program instructions (for example, software and/or firmware) stored on a memory accessible to the processing circuitry (for example, memory 14, and/or the like).

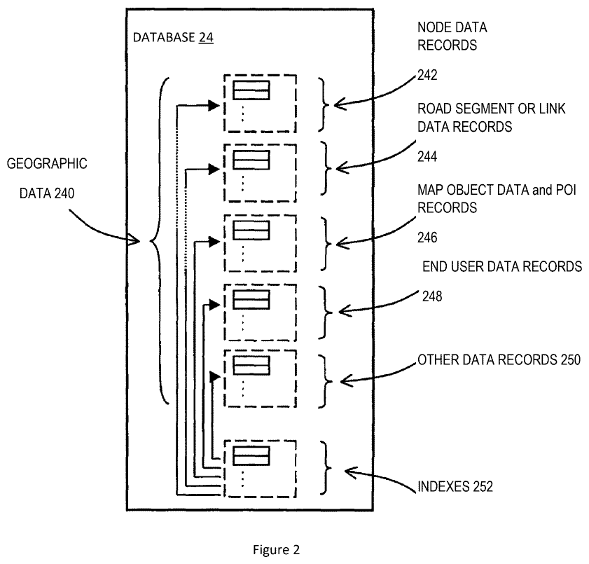

Turning to FIG. 2, the map or geographic database 24 may include various types of geographic data 240. This data may include but is not limited to node data 242, road segment or link data 244, map object and point of interest (POI) data 246, end user data records 248, or the like (e.g., other data records 250 such as charge point data, dynamic power sharing data, etc.). The other data records 250 may include real time and historical data on a given charging location (e.g., an EVSE such as a charge point and/or individual cords or plugs of that charge point). The other data records may also include metadata about the charge points such as maximum theoretical charging capabilities, instantaneous charging capabilities, etc. End user preference data may also be accounted for in one or more databases. For example, preferred charging settings, time, level, etc. (see End User Data Records 248).

In one embodiment, the following terminology applies to the representation of geographic features in the database 24. A “Node”—is a point that terminates a link, a “road/line segment”—is a straight line connecting two points, and a “Link” (or “edge”) is a contiguous, non-branching string of one or more road segments terminating in a node at each end. In one embodiment, the database 24 follows certain conventions. For example, links do not cross themselves and do not cross each other except at a node. Also, there are no duplicated shape points, nodes, or links. Two links that connect each other have a common node.

The map database 24 may also include cartographic data, routing data, and/or maneuvering data as well as indexes 252. According to some example embodiments, the road segment data records may be links or segments representing roads, streets, or paths, as may be used in calculating a route or recorded route information for determination of one or more personalized routes. The node data may be end points (e.g., intersections) corresponding to the respective links or segments of road segment data. The road link data and the node data may represent a road network, such as used by vehicles, cars, trucks, buses, motorcycles, bikes, scooters, and/or other entities.

Optionally, the map database may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, EV charging stations, hotels, restaurants, museums, stadiums, offices, auto repair shops, buildings, stores, parks, etc. The map database can include data about the POIs and their respective locations in the POI records. The map database may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) associated with the POI data records or other records of the map database.

The map database 24 may be maintained by a content provider e.g., the map data service provider and may be accessed, for example, by the content or service provider processing server. By way of example, the map data service provider can collect geographic data and dynamic data to generate and enhance the map database and dynamic data such as traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile device, as they travel the roads throughout a region.

The map database 24 may be a master map database, such as an HD map database, stored in a format that facilitates updates, maintenance, and development. For example, the master map database or data in the master map database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map database 24 may be a master geographic database, but in alternate embodiments, a client-side map database may represent a compiled navigation database that may be used in or with end user devices to provide navigation and/or map-related functions. For example, the map database may be used with the mobile device to provide an end user with navigation features. In such a case, the map database can be downloaded or stored on the end user device which can access the map database through a wireless or wired connection, such as via a processing server and/or a network, for example. It should be noted the map database 24 may also include data regarding the interiors of buildings, homes, offices, etc. to aid the system, apparatus, etc. in tracking end user location as the end user moves around one location or between locations.

The records for end user data 248 may include various points of data such as, but not limited to: end user location data (at a first location, second location, etc.), end user payment data, charging need and preference data, end user driving profile data (e.g., driving tendencies, preferences, etc.), data concerning a user's typical travel routine, and other end user data useful for determining if an end user will likely use a proximate EV charger. The manner by which the apparatus 10 records and stores data may vary, and the examples discussed herein are non-limiting.

The end user location data may, in some embodiments, include data obtained from GNSS, GPS, NFC, Wi-Fi triangulation, cellular tower information, micro-mobility data, image data of the end user, radio map data, etc. It should be noted that throughout this disclosure, end user location data may include location data of an end user and/or their end user device(s) or vehicle(s). In some situations, it may be more useful to track end user location generally or track specific location of an end user device or vehicle. For example, if an end user exits their vehicle at a charging location, it may be more useful to track the location of their EV than the location of the mobile phone. Such determination may be made in real time by the system in some embodiments.

End user payment data may include credit card information, digital wallet information (e.g. Apple Wallet, etc.), online payment system information (e.g., PayPal, Venmo, etc.), bank account information, cryptocurrency wallet information, etc. The payment data recorded and stored by the system may also include metadata about such payments including rewards programs, loyalty programs, bonuses, incentives, etc.

End user driving profile data such as end user driving patterns (e.g., cautious, slow, fast, etc.) may be obtained by any functional manner including those detailed in U.S. Pat. Nos. 9,766,625 and 9,514,651, both of which are incorporated herein by reference.

End user data may also include information about individual electric vehicles and their characteristics (both generalized data and/or one-off specific data profiles). Information such as common charging times, battery degradation, charging profiles, charging preferences, typical charging locations, and charging curves may be stored by the system, apparatus, etc. to be utilized as needed.

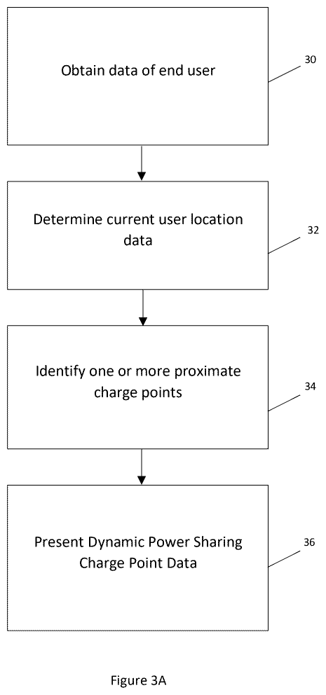

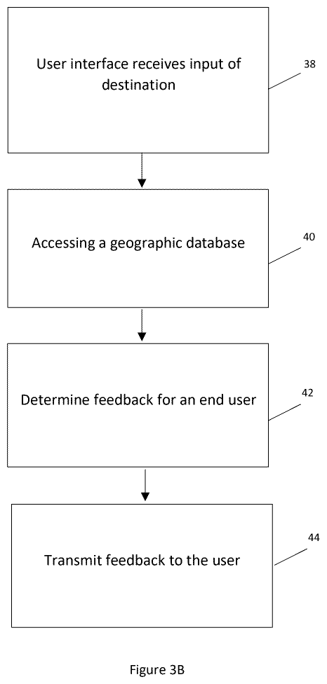

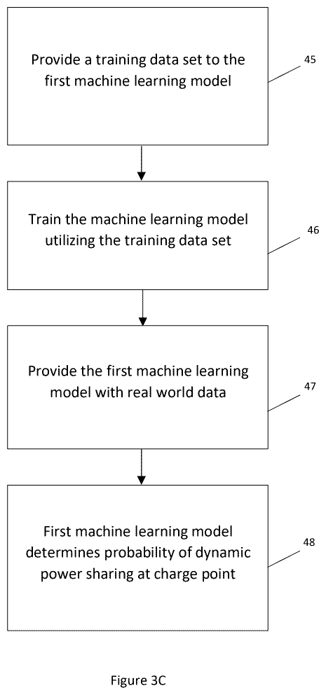

FIG. 3A is a flowchart which demonstrates how the apparatus 10 identifies an end user's location and then presents or suggests a charge point with dynamic power sharing. More, fewer, or different acts or steps may be provided. At a first step (block 30) the apparatus may obtain one or more pieces of GNSS data, images, audio, or other data of at least one end user. This data may be obtained from an end user device via positioning system(s), the camera of a device, or other means commonly found in an end user device such as a smart phone. Data may also be obtained from various programs, apps, websites, etc., running on said end user device such as location guidance apps (e.g., Google Maps, Here We Go, etc.), messaging apps, social media networks, scheduling applications and/or data, etc. Data may also be captured from the camera system of a vehicle or even traffic cameras, security cameras, etc. The apparatus may be trained to analyze the data (see FIG. 3C) via machine learning model(s) or any other functionally capable means to identify/predict the end user's location at a given time and thus their likelihood of being proximate to a certain charge point.

The data captured by the system may include but is not limited to location GNSS/GPS data for a vehicle, end user, etc. The presently disclosed system, apparatus, etc. may monitor, track, etc. the location of an end user at various locations throughout their day, when they travel outside a predefined area, along a suggested route, etc.

For example, if an end user drives down a roadway on a given day in an EV the apparatus 10 may track the end user's location when their battery level drops below 20% (or some other preset level). Once the EV battery level is below this charge level, the apparatus 10 may utilize GNSS data, image data, etc. to determine the end user's location with a high degree of accuracy. This is one example of how the system might determine the location of an end user (block 32).

Once the end user's location has been identified, the apparatus may then identify one or more charge points (block 34) which the end user is traveling near or towards. The location of the charge point may be determined based on a threshold such as within a predefined distance (e.g., 100 meters) or dynamically determined based on surrounding POIs, etc. For example, if an end user is driving down a rural roadway the nearest charger might not be for several miles and thus the apparatus may adjust its criteria for proximate location in such a situation. Factors such as remaining battery charge, fuel levels (in hybrid cars), etc. may also be used by the apparatus 10 when assessing proximate charge points.

The identification of the relevant nearby charge points may be done via an end user device and/or vehicle's onboard GPS (see FIG. 1) or any other functional means. Once an end user location has been identified as within or close to a given charge point, charge station, charge kiosk, ESVE, or any device capable of charging an EV; the apparatus may then prepare, present, and/or transmit dynamic power sharing data for an EV charge point (block 36) to optimize charging.

In one embodiment, the apparatus may utilize various data about charge point(s) to suggest or automatically select one or more charging stations based on the expected instantaneous charging power of stations (including dynamic power sharing information) nearby or along a travel route. This is accomplished by considering data such as current real-time EVSE availability or EVSE availability predictions, information or predictions on whether dynamic power sharing is used, and nominal (e.g., manufacturer stated) or expected charging power based on whether dynamic power sharing is available along with the number of EVSE in use/available at a given location.

The apparatus may utilize predictions to estimate if some of the EVSE at a location are expected to become free during a given charging event thus increasing the potential charging power. For example, if dynamic power sharing is used and a first EV is to be charged for 40 min while a second EV for an hour, the last 20 min of the charging for the second EV may go faster. This is because the first EV will no longer be using power from the EVSE. This predicted faster charging for a portion of the charge event may also be adjusted if a third EV indicates it will begin charging in 50 minutes at the same EVSE, thus potentially taking away some of the power used to charge the second EV (if it is still charging).

Turning to FIG. 3B, the apparatus 10 may support a user interface 18 (shown in FIG. 1). More, fewer, or different acts or steps may be provided. At a first step, the user interface may receive an input of destination from an end user (block 38). This input of destination may be received via an end user device graphical user interface (GUI) running upon a smartphone, tablet, integrated vehicle navigation system, etc. Once a destination is input, the apparatus may then access a geographic database (block 40) and determine a route to the input destination (block 42). The determined route may, in some embodiments, avoid (or select) at least one road segment in response to an electric vehicle charging location with dynamic power sharing. As mentioned above, the determination of the EV charger(s) to suggest to an end user may be based on any functionally capable means including proximity and other data or metadata about charge points, power sharing, end user preferences, payment methods, etc.

Notwithstanding how the apparatus generates a determination of the EV charger to suggest to an end user, this information may then be used to route an end user towards or away from certain road segments when generating a route. The route determined by the apparatus 10 may then be displayed to the end user (block 44) via the same or a different user interface. The apparatus can take any number of additional actions (or in place of) what is called for in block 44. For example, the apparatus may provide audio guidance instead of a visual display. The navigation instructions may also be provided to an autonomous vehicle for routing (for example, without any display to the user). It should also be noted the UI can be run by a processor and stored upon one or more types of memory in some embodiments.

An example of the above embodiment would be that of an end user approaching a charger. Not all chargers are well marked nor is it typically outlined what charging power may be utilized at a given charge point. Based on data in one or more geographic databases, etc. the apparatus 10 may predict or determine that a given vehicle should be routed to one EV charger over another if both chargers are proximate to the vehicle. This decision may be carried out by a machine learning model (see below) in some embodiments based on information about the electric vehicle (e.g., compatibility with a given charge point), charge needs, EVSE power sharing data, charge point availability, etc.

Referring now to FIG. 3C, the operations performed, such as by the apparatus 10 of FIG. 1, in order to train a machine learning model to detect and/or predict the likelihood a charge point has dynamic power sharing based on one or more indicators. More, fewer, or different acts or steps may be provided. As shown in block 45, the apparatus 10 includes means, such as the processing circuitry 12, memory 14, the communication interface 16 or the like, for providing a training data set that includes a plurality of training examples. In this regard, the training data set may be provided by access by the processing circuitry of the training data set stored by the memory. Alternatively, the training data set may be provided by access by the processing circuitry to a database 24 or other memory device that either may be a component of the apparatus or may be separate from, but accessible to the apparatus, such as the processing circuitry, via the communication interface. It should be noted the system apparatus may utilize more than one machine learning model to carry out the steps described herein.

In accordance with an example embodiment, the apparatus 10 also includes means, such as the processing circuitry 12, the memory 14 or the like, configured to train a machine learning model utilizing the training data set (block 46). The machine learning model, as trained, is configured to detect and predict electric vehicle charge point dynamic power sharing indicators (and availability of DPS EVSE). The prediction may be based, at least in part, upon end user location data (obtained from GNSS, etc.) and charging need data for a given EV.

The apparatus 10, such as the processing circuitry 12, may train any of a variety of machine learning models to identify indicators based upon a single or plurality of data points, images, audio, etc. Examples of machine learning models that may be trained include a decision tree model, a random forest model, a neural network, a model that employs logistic regression or the like. In some example embodiments, the apparatus, such as the processing circuitry, is configured to separately train a plurality of different types of machine learning models utilizing the same training data including the same plurality of training examples. After having been trained, the apparatus, such as the processing circuitry, is configured to determine which of the plurality of machine learning models predicts interaction indicators with the greatest accuracy. The machine learning model that has been identified as most accurate is thereafter utilized.

In one example, the machine learning model may be a deep learning neural network computer vision model that utilizes user location data, communication data, scheduling data, etc. to automatically identify power sharing indicators. A training example for this first machine learning model may include data demonstrating known travel patterns, routines, etc. for end users. For example, when various end users utilize a given charge point simultaneously various data may be observed by the apparatus such as: the length of time for a charge, amount of power (e.g., max Watts received by an individual EV), the peak power received by all EVs at once, etc. These same data points may also be observed when a single car is utilizing the same EVSE to determine if there are different power levels received. Based on this data, the apparatus may deduce if dynamic power sharing is in effect. The apparatus may then also use this data to examine other EVSE with similar usage statistics to predict the use of dynamic power sharing at these various other charge points, etc.

Various types of metadata about the charge points may also be provided to the machine learning model to train and improve its accuracy. For example, if a charge station is known to have dynamic power sharing capabilities, this data may be used to confirm other charge points as having dynamic power sharing as well (e.g., same make or model of EV charger).

In some example embodiments, a balance or trade-off between the accuracy with which the indicators are identified and the efficiency with which the machine learning model identifies them is considered. For example, a first set of data, images, audio, etc. may produce the most accurate identification, but a second combination of data, images, audio, etc. may produce an identification of indicators (e.g., GNSS data, image data, scheduling data.) that is only slightly less accurate, but that is significantly more efficient in terms of its prediction. Thus, the second combination of data that provides for sufficient, even though not the greatest, accuracy, but does so in a very efficient manner may be identified by the apparatus 10, such as the processing circuitry 12, as the data for end users to be provided to the machine learning model to identify EV charge interaction indicators in subsequent instances.

In some embodiments, a training example also includes information regarding a map object, such as a map object that is located at the location where charging of an EV occurs. One example of a map object is a bridge, and another example of a map object is a railroad crossing or median. A wide variety of other map objects may exist including, for example, walls/fences, manhole covers, transitions between different types of road surfaces, medians, parking meters, various forms of infrastructure, or the like. As described in more detail below, the map object that is included in a training example may be determined or provided in various manners. For example, the map object may be defined, either manually or automatically, by reference to a map database 24 and identification of a map object at the same location or at a location proximate, such as within a predefined distance of, the location at which the corresponding image data was captured. The training example may also include point of interest (POI) data. A POI may be something like a single EV charge point (any public or private EVSE), a larger charging station, hospital, restaurant, park, school, bus stop, etc. Relevant POIs may also be defined, either manually or automatically, by reference to a map database 24 and identification of a POI at the same location or at a location proximate, such as within a predefined distance of, the location at which the corresponding image data was captured. The location of relevant POIs and/or map objects may be found by GPS coordinates or any other functionally capable means.

Yet other various types of data may also be utilized when training the machine learning model including map geometry data, historic data, indoor mapping data, geolocation data, Wi-Fi mapping (e.g., triangulation) data, hotspot data, etc. Ground truth data may also be utilized with a combination of these different features for supervised machine learning.

It should also be noted in some examples that the apparatus, system, etc. may monitor charge point availability in addition to dynamic power sharing locations. In some cases, EV chargers are occupied for longer stretches making them less useful to suggest to a proximate end user who needs immediate charging. Such data may be obtained and monitored by apparatus 10 in real-time from charge point operators, camera systems, etc.

Once trained, the machine learning model may then be provided various real-world data as mentioned in block 47 and used to determine EV charge point dynamic power sharing indicators.

An example of the apparatus 10 detecting and/or predicting an EV charge point with dynamic power sharing may be based on various factors. For example, as an end user travels the roadways, EV battery range may be determined by the apparatus 10 based on real-time data transmitted from the EV or estimated based on the range the given EV typically drives. In this example, the end user may set up an automatic alert for when their EV battery is below 30% charge. Once this charge level is depleted to this low level, the apparatus 10 may examine the current GNSS location data for the end user's mobile device (or via their EV's internal systems) and suggest one or more EV chargers in the area. The suggested chargers may be presented as a UI list, audio suggestion, or any other useful means.

The apparatus 10 may prioritize various EVSE on the list of suggested EV charging locations based on the presence of dynamic power sharing (either confirmed or predicted). The machine learning model in this example makes its determination based on a combination of specific factors (map data, charge point data, image data, location data, scheduled charge data, etc.), and the model predicts the potential of dynamic power sharing charging because of specific factors in a specific combination or configuration are present. The factors in this example may include data extracted from the end user's physical location at various times (e.g., at least a first time), image data of roadways/charge points, as well as time of day data, historic charge data, etc. This set of data, provided to the model, matches (or is like) the factors used in the training process (in this example). This allows the machine learning model to predict if a given charge location is likely to have dynamic power sharing capabilities and if they were to charge their car at this location, how dynamic power sharing would impact their charging session (block 48).

The apparatus 10 may also use various events to trigger obtention of end user or device location. These might include but are not limited to a series of predefined time intervals, on end user demand, on application invocation/start up, or upon powering on of an end user device. Obtention of the first location of an end user device may also be triggered by change of cell tower or change of mobile network the end user device is connected to or a change in the Wi-Fi access points detected by the end user device. NFC communication with one or more charge points may also establish an end user/EV location.

The determination of one or more dynamic power sharing charge point indicators can then be utilized in various ways. For example, the apparatus 10 may alert end users via graphical user interface that they could be using a charger with more power available nearby or that their estimated charge time may be longer or shorter depending on power sharing during a given charge session. The apparatus 10 might also automatically update one or more software or device settings if dynamic power sharing is indicated as available at an EVSE and may also update one or more map layers and/or databases to account for this determination. These entries may also be used to update settings for a given end user or other end users automatically in the future. It should be noted end users of the apparatus 10 might be human end users, automated devices, software clients, etc. In some embodiments, the data from the apparatus 10 may also be integrated into one or more additional software solutions/services.

As mentioned before, the apparatus 10 features one or more machine learning models. This model and other data may be used by the apparatus 10 to not only analyze real time driving situations as mentioned above but also examine existing map data to identify other similarly situated charge points. These similar charge points may have around them similar POIs, map objects, etc. So, for example, if there was a roadway near an EV charger which users typically navigate to, the apparatus 10 may be able to detect these similar roadways with proximate EV chargers in other areas and provide alerts, settings updates, route guidance, etc. to another end user about predicted dynamic power sharing capabilities.

It should be noted that in some embodiments the machine learning models may predict if dynamic power sharing exists at a given charge point and also predict if this charge point will be available for a given end user to utilize it when needed.

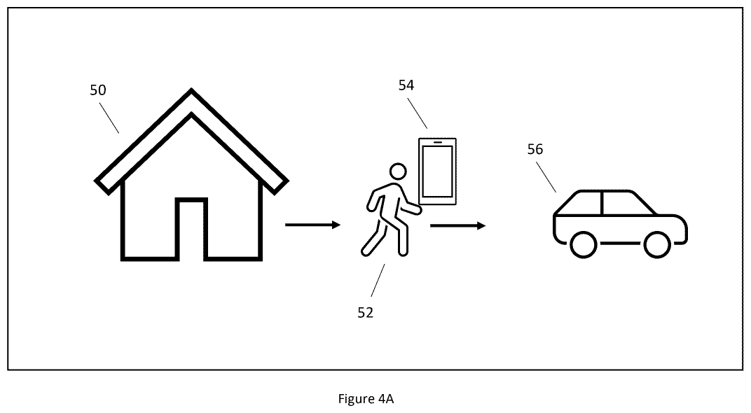

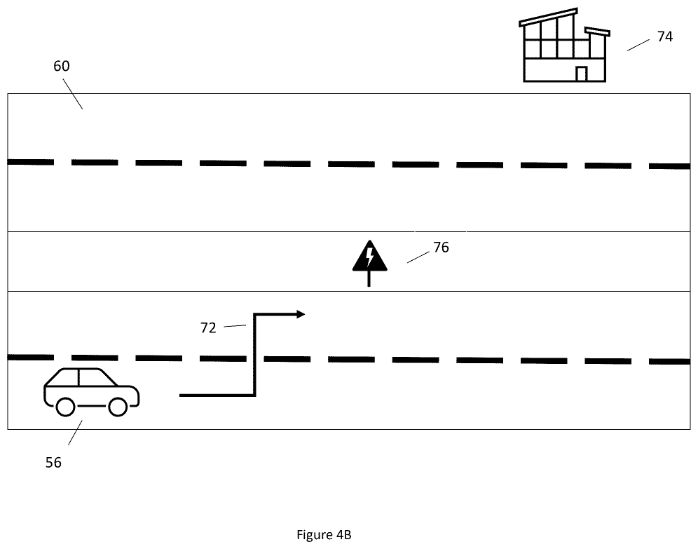

Turning to FIG. 4A, some of the examples discussed above are illustrated. Specifically, an end user 52 is shown exiting their home 50 and approaching their sedan 56. As shown in FIG. 4A, the end user 52 is utilizing apparatus 10 upon their end user device 54 to detect and/or predict dynamic power sharing EV charge point utilization. The apparatus 10 identifies the user's location (moving from house to car) via GNSS data and/or images from a camera system 22 (or other security cameras, traffic cameras, etc.) and feeds those images into the machine learning model along with other data such as information concerning if the end user has booked a time at a charging location (obtained from EV charge point operator data, end user scheduling data, SMS data, etc.). The apparatus then takes this data along with relevant other information such as POI or image data of roads in the area, etc. and feeds all the data to the machine learning model (or to another model, algorithm, etc.) to determine if the given end user will likely be utilizing a charge point.

It should be noted that the sedan 56 in this example may represent any vehicle. Such vehicles may be standard gasoline powered vehicles, hybrid vehicles, an electric vehicle, a fuel cell vehicle, and/or any other mobility implement type of vehicle (e.g., bikes, scooters, etc.). The vehicle includes parts related to mobility, such as a powertrain with an engine, a transmission, a suspension, a driveshaft, and/or wheels, etc. The vehicle may be a non-autonomous vehicle, assisted driving vehicle, or an autonomous vehicle. The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one embodiment, the vehicle may be assigned an autonomous level. An autonomous level of a vehicle can be a Level 0 autonomous level that corresponds to a negligible automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

In one embodiment, a graphical user interface (GUI) may be integrated in the vehicle, which may include assisted driving vehicles such as autonomous vehicles, highly assisted driving (HAD), and advanced driving assistance systems (ADAS). Any of these assisted driving systems may be incorporated into the GUI. Alternatively, an assisted driving device may be included in the vehicle. The assisted driving device may include memory, a processor, and systems to communicate with the GUI. In one embodiment, the vehicle may be an HAD vehicle or an ADAS vehicle. An HAD vehicle may refer to a vehicle that does not completely replace the human operator. Instead, in a highly assisted driving mode, a vehicle may perform some driving functions and the human operator may perform some driving functions. Such vehicle may also be driven in a manual mode in which the human operator exercises a degree of control over the movement of the vehicle. The vehicle may also include a completely driverless mode. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands. The automated controls may also specifically interact with an automated charge point to enable automated charging.

In this example, the end user 52 does not have an EV charger at their home thus routinely visits a charge point nearby. Based on their leaving their home with an EV charge of below 50%, the apparatus 10 may deduce the end user is likely going to go charge their EV at the given charge point. Additionally, if dynamic power sharing is available at this charge point the apparatus may deduce the amount of power available to the end user and suggest they or another user charge later to enable faster charging. This faster charging may be suggested based on the individual charging times and charging curves of each EV with the apparatus creating a staggered schedule of charging times which allows multiple EVs to get the most power in the most efficient way possible.

In some embodiments, the apparatus 10 may extract information by use of OCR and/or NLP. In one embodiment, the apparatus 10 may use optical character recognition (“OCR”) in conjunction with one or more databases (see FIG. 2) to determine text or characters of a sign or marking for EV chargers and if they have DPS charging. Additionally, the apparatus 10 may compare features or components (such as invariant components relating to an emoji) in or from images to reference features or components in one or more reference databases (or data libraries) to detect a symbol or feature (such as angry emojis, exclamation points, etc.). The apparatus 10 may then record (in a database) the determined text, the identified symbols and/or graphics thereof, and/or other features or determinations. For example, the end user 52 may be driving past a road sign that says, “EV CHARGING TEN MILES”. The apparatus 10 can extract this text along with any exclamation points, symbols, emojis, etc. and use this information to determine the message's meaning and content, at least in part, by comparing the message's content to a current database of reference information.

As mentioned above, OCR may be used to extract the information from an end user message and natural language processing (NLP) technologies may be used in conjunction with the OCR tools to aid the apparatus 10 in analyzing the messages. NLP may be used in some embodiments to address issues around word segmentation, word removal, and summarization to determine the relevancy of the various parsed data. In various embodiments, semantics of the various parsed data are determined based on a vocabulary model in a grammar module. For example, in various embodiments, probabilistic latent semantic indexing (pLSI) or Latent Dirichlet allocation (LDA) may be used to deduce semantics from words in the extracted message information and determine the information's relevancy. Such methods can be used to derive text and topics from a set of predefined terms.

Continuing with the road sign example from above, the apparatus 10 may see details on the sign for the charge point which states the number of chargers available, etc. If multiple chargers are available this may be a helpful factor which enables the deduction that a given charger/EVSE has dynamic power sharing capabilities.

Based off this information, the apparatus may provide to the end user 52 feedback, alerts, suggestions, etc. In some embodiments, this feedback might be computerized instructions which cause one or more software programs and/or devices to change one or more settings to create signals for autonomous driving control. The information may also be used to provide route guidance to avoid certain charge points due to power constraints, etc. Alerts, settings updates, and routing information may also be provided to other user(s) in the area.

The feedback generated may also be used to select a preferred set of charging locations. For example, some end users may wish to charge their EV as fast as possible. If a local charger or supercharger is typically not in use over night, the apparatus 10 may note this location a preferred due to the ability to charge quickly with no likely drop off in charging speed due to power sharing.

Route guidance, when generated, may include various guidance options, visual and/or audio. For example, visual guidance on how and when to change lanes or audio guidance relaying the same information. Automatic driver controls like those for an autonomous vehicle (e.g., an automatic lane change that can include an explanation to the passenger on what is happening), etc. The guidance itself can include the alert messages as mentioned above so the generation of alerts and route guidance can be the same function. When calculating the route and route guidance, metadata such as a data flag or attribute of road segments may be taken into consideration when forming different suggested routes and one or more segments may be excluded from these routes when it is determined (by the apparatus) that one or more interaction area indicators are associated with the omitted segment(s).

In some embodiments, apparatus 10 may generate a confidence interval/score which reflects the likelihood an end user will interact with a given charge point. Building on one of the examples above, the apparatus 10 can detect an end user location, EV charge level, and the road sign indicating an EV charger is nearby. From this, the apparatus 10 may generate a score of 0.75 out of 1 (on a scale of 0-1). The apparatus 10 may then receive additional information from other sources (e.g., ongoing updates to end user location data, metadata traffic camera data, traffic alerts, real-time driving behavior of the end user, etc.) which can increase or decrease this confidence score. For example, if the EV charge level drops to 5% and there are no other EV charge points proximate to the EV, the confidence score may be boosted. Alternatively, if the EV charge point is not compatible with the given EV, the confidence score may be reduced.

It should be noted that the confidence interval/score described above may itself act as an indicator of dynamic power sharing charge point presence or availability and/or may also be used as part of a greater analysis and combined with other factors when determining likelihood of an EV charger with dynamic power sharing being available for use.

FIG. 4B illustrates another example embodiment. Specifically, the sedan 56 from FIG. 4A is shown driving down a roadway 60. As shown in FIG. 4B, the sedan 56 is utilizing the apparatus 10 to adjust and manage EV charge point usage. The apparatus 10 identifies the sedan 56 based on the information discussed above and feeds the GNSS data, images, etc. into a machine learning model which determines the likelihood the end user driving the sedan 56 will utilize EV chargers in the area. In this example, the end user is headed to a shopping mall 74 along the roadway. The end user is navigating to the mall by use of a GPS navigation system which is proving routing information 72.

As the end user travels down the roadway, they pass a road sign 76 which indicates the mall 74 has EV charging available. This determination may be made by the apparatus 10 by use of image data of the sign 76 analyzed by OCR, NPL, and/or machine learning (discussed above) to extract the sign 76 information. This sign may also indicate the number of charge spots open in real time, for example “2 Open Charge Spots”.

In this example, since the routing information is guiding the end user towards the mall 74 and the mall is confirmed to have EV charging, the apparatus 10 may detect when the end user gets close to the charge point as confirmed by GNSS data, car camera systems, security cameras, etc. The apparatus may then produce one or more types of feedback (discussed above). One such type of feedback may be updating the availability and charging time estimates for a given charge point. Other feedback may include if dynamic power sharing is occurring at the mall's charge points.

It should be noted that the application(s) activated by the apparatus 10 feedback (based on location data, etc.) may include applications for EV control supported by vehicle OEMs. The applications may also include those which grant access to national or regional charging station networks such as the networks operated by: 7Charge, Blink, ChargePoint, Electrify America, Electrify Canada, EVgo, FLO Network, Shell Recharge, the Tesla Supercharger Network, Volta Charging, West Coast Electric Highway, and/or PlugNYC. As mentioned above, most EVs have an accompanying smartphone application which can enable vehicle functions such as remote start, remote unlock, etc. The apparatus 10 is envisioned to, in some embodiments, send data/feedback to and from these EV smartphone applications in real-time for navigation, charge data recordation, payment transmission, etc.

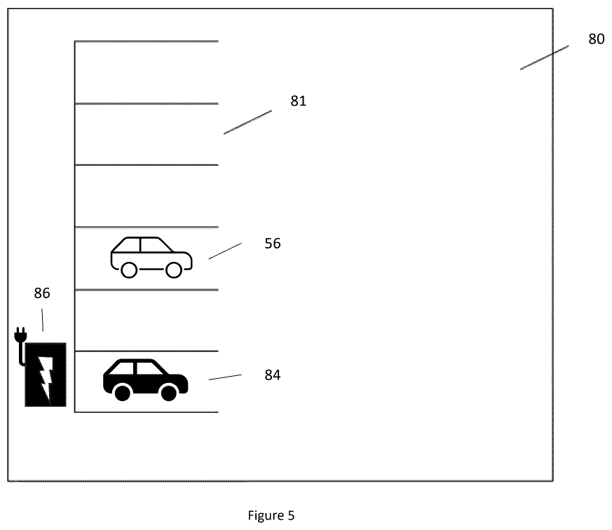

FIG. 5 illustrates another example embodiment. As shown, a mall parking lot 80 contains parking spaces 81 some of which are normal parking spaces and others are designated for EV parking and located by an EV charge point 86. In this example, the end user of sedan 56 has navigated to the mall parking lot 80 with an EV battery level of 10%. The apparatus 10 may determine that there is a high likelihood the sedan 56 will be charged at the charge point 86 based on this information. The apparatus 10 may automatically confirm the charge point is active, compatible, available, etc. In this example, another car 84 is currently utilizing the charge point 86 but, this charge point has two available charging cables so the end user of sedan 56 may also access the charge point 86. In this example, the end user of the sedan 56 is altered to the situation by the apparatus 10 and shown which parking spaces 81 they may park at in the lot 80 to access the charge point 86. Such data, in this example, is obtained in real-time from the charge point 86 operator via the internet.

In this example, the sedan 56 has a low battery charge level and it will take an estimated 1 hour for their EV battery to charge to 100%. The other EV present is at 50% charge at it will take an estimated 30 minutes for it to completely charge based on the stated known max power output of the given charge point. When the newly arriving sedan 56 plugs into the charge point, data such as the actual peak power available, etc. may be observed by the apparatus 10 in real time. This peak instantaneous power may differ from the stated max power based on limitations around the local power grid, how dynamic power sharing is set to function by the charge point operator, etc. This real time data may be used by apparatus 10 as feedback to update one or more databases, route vehicles, etc. This data may also be utilized by the apparatus 10 to predict the presence and/or availability of dynamic power sharing at other EVSE. Such real time data may be obtained from charge point operators or deduced by the apparatus 10 monitoring charge speed, incoming power levels, etc. from various EV's internal systems. This data may also be used to update the charge time estimates for the EVs.

The apparatus 10 may also use a cost function/algorithm to consider the number of available EVSE (more available, more power per EVSE) and their nominal max charging power, as well as the expected/derived charging power (known or estimated). This cost function may enable the apparatus 10 to prioritize or deprioritize suggested EVSE depending on end user preferences (e.g., fastest charging available), lowest cost, most efficient for all EVs needing to charge, least strain on the power grid, etc.

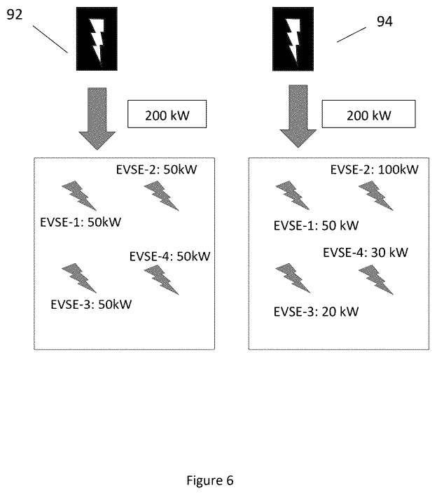

FIG. 6 is a diagram illustrating two charge points one of which has dynamic power sharing (DPS) capabilities and one which has static power distribution. As shown in FIG. 6 the non-DPS EV charger 92 has a maximum power supply of 200 kW. This supply of 200 kW is spilt up amongst the charging EVs (EVSE plugs 1, 2, 3, 4) in this example at a set rate of 50 kW. The power supply of 50 kW is supplied by the charger 92 (in this case via charge plugs/cords) to the various connected EVs and does not modulate the power level up or down in response to charging curves, load balancing, etc. In contrast the DPS enabled EV charger 94 also has a maximum power supply of 200 kW but the power provided to the charging EVs may be modulated up and down. As shown, EVSE-1 is given 50 kW, EVSE-2 is given 100 kW, EVSE-3 is given 20 kW, and EVSE-4 is given 30 kW. This distribution of power may be based on a first come first serve basis, based on individual EV charging curves, etc. Such power distribution might also be monetized based on one end user paying more for quicker charging via extra power provided by the DPS enabled charge point 94.

In some embodiments, the apparatus 10 may route to or from a given charge point due to the presence of or absence of DPS charging. One example might be an end user who wishes to charge quickly and in response to DPS being present, can receive the full power a given charger can provide (potentially up to 200 kW in the example above). This is because the DPS charge point 94 is able to send all power to one plug, cord, etc. when no other EVs are present. Alternatively, if three other EVs are using the DPS charge point 94 it might mean a newly arriving EV will only get 20 kW to start. In response to this, the apparatus 10 may route a given EV to another charge point which can provide more charging power.

As mentioned above, DPS provides the ability to modulate the amount of power sent to various simultaneously charging EVs. In some embodiments, the apparatus 10 may overlap the charging curves of multiple EVs to best manage charging needs versus time, speed, etc. For example, every EV has its own unique charging needs which may be described as a charging curve based on battery capacity, age, deterioration, charging capacity (some cars may use supercharging, etc.) and other factors. Some end users may also have certain preferences for charging (like never dropping below 20% battery charge, 50%, etc.) which may also impact an EV's charging needs. With this in mind, the apparatus may in some embodiments obtain data for individual EVs in the form of end user profiles, car data profiles, battery profiles, etc. (see End User Data records 248 above) and analyze this data in real time to determine a charging curve for each EV. The apparatus 10 may then control the DPS of a given charge point to send more power to EVs which need it and lower power to EVs at the tail end of charging, etc. Each charging curve can be used to determine when max power is needed for a given EV and if two EVs will need max power concurrently, the apparatus 10 may route one of these EVs to another charge point to better serve the needs of both end users.

The calculations above may be done in real time for a charge station near a given EV as it travels down the road or may be used for long range routing. When an EV travels a long range, it will need to make multiple stops to charge and the apparatus 10 may account for these planned or even scheduled stops when directing and routing EVs to certain charge points. For example, if a cross-country traveler is planning on charging their EV at night at a hotel charger there is a good chance that the EV needs lower power than a local EV driver who has stopped at the same hotel EV charge point because their battery is near zero. Thus, the apparatus 10 might direct more power to the local EV user who only needs a few minutes of charging to be on their way while the overnight hotel guest's EV might be given lower power via DPS as their car will still be fully charged by morning. In some embodiments, the apparatus 10 may even keep an EVSE open for the expected traveler, wherein this reserved EVSE is capable of fulfilling the particular end user's charge needs; while routing others to nearby charge stations to satisfy all needs.

In another embodiment, the apparatus, system, etc. may also detect or predict blocked charger indicator(s). A blocked charger may be described as an EVSE which is occupied but not in use. For example, as mentioned above in FIG. 5 an EV will complete its charging session in the mall parking lot. After this, the EV will stop actively using the charge point, but will still physically occupy a parking space potentially stopping another EV from using the charge point. This physical blocking of the charge point may be detected by image data of vehicle, location data, charging data, etc. and can be used to determine dynamic power sharing presence and availability for a given charge point. Blocked charger indicator(s) may also be detected by information provided by charge point operators and/or independently determined. For example, the power levels sent to various EVs using the same EVSE may be monitored by the apparatus in communication with one or more of the EVs. This data combined with location data, etc. may enable the apparatus to determine an uptick in power levels when one EV completes its charge. This power modulation indicates that there is DPS in use at the EVSE (and that at least one of its charging cords may now be blocked). The blocked charger indicator may also be determined by end user device location data. For example, if an end user device is located within the shopping mall of the example above while their car is located at the charge point, this physical separation may indicate that then EV user is shopping at the mall and thus potentially creating a blocked (potentially DPS enabled) charger.

It will be understood that each node block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 14 of an apparatus 10 employing an embodiment of the present invention and executed by the processing circuitry 12. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Furthermore, in some embodiments, additional optional operations may be included. Modifications, additions, or amplifications to the operations above may be performed in any order and in any combination.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
obtaining an indication of at least a first location of an electric vehicle and charging need data of the electric vehicle;
obtaining charging data for one or more electric vehicle charge points proximate to the first location of the electric vehicle;
determining a dynamic power sharing availability indicator based, at least in part, on the charging need data of the electric vehicle and a predicted arrival time for the electric vehicle at the one or more electric vehicle charge points proximate to the first location of the electric vehicle; and
updating at least one database record with the determined dynamic power sharing availability indicator.

2. The method according to claim 1, wherein the first location of an electric vehicle is captured by a combination of GNSS data and vehicle sensor data.

3. The method according to claim 1, wherein dynamic power sharing availability indicator is determined at least in part on a preset battery charge level of one or more of the more electric vehicles utilizing one charge point proximate to the first location of the electric vehicle.

4. The method according to claim 1, wherein dynamic power sharing availability indicator is determined at least in part on an EV charging curve of one or more of the more electric vehicles utilizing one charge point proximate to the first location of the electric vehicle.

5. The method according to claim 1, wherein dynamic power sharing availability indicator is determined at least in part on the max nominal charging power of one or more of the more electric vehicle charge points proximate to the first location of the electric vehicle.

6. The method according to claim 1, wherein dynamic power sharing availability indicator is determined at least in part on the instantaneously available charging power of one or more of the more electric vehicle charge points proximate to the first location of the electric vehicle.

7. The method according to claim 1, wherein the determined dynamic power sharing availability indicator is determined at least in part on real-time data from a charge point operator.

8. The method according to claim 1, wherein the determined dynamic power sharing availability indicator is used to route one or more electric vehicles to an electric vehicle charge point.

9. The method according to claim 8, wherein the routing data for at least two electric vehicles are used to update a dynamic power sharing availability indicator.

10. An apparatus, the apparatus comprising at least one processor and at least one memory storing computer program code, the at least one memory and the computer program code configured to, with the processor, cause the apparatus to at least:
obtain an indication of at least a first location of an electric vehicle and charging need data of the electric vehicle;
obtain charging data for one or more electric vehicle charge points proximate to the first location of the electric vehicle;
determine a dynamic power sharing availability indicator based, at least in part, on the and charging need data of the electric vehicle and a predicted arrival time for the electric vehicle at the one or more electric vehicle charge points proximate to the first location of the electric vehicle; and
update at least one database record with the determined dynamic power sharing indicator.

11. The apparatus of claim 10, wherein the first location of an electric vehicle is captured by a combination of GNSS data and vehicle sensor data.

12. The apparatus of claim 10, wherein dynamic power sharing availability indicator is determined at least in part on a preset battery charge level of one or more of the more electric vehicles utilizing one charge point proximate to the first location of the electric vehicle.

13. The apparatus of claim 10, wherein dynamic power sharing availability indicator is determined at least in part on an EV charging curve of one or more of the more electric vehicles utilizing one charge point proximate to the first location of the electric vehicle.

14. The apparatus of claim 10, wherein dynamic power sharing availability indicator is determined at least in part on the max nominal charging power of one or more of the more electric vehicle charge points proximate to the first location of the electric vehicle.

15. The apparatus of claim 10, wherein dynamic power sharing availability indicator is determined at least in part on the instantaneously available charging power of one or more of the more electric vehicle charge points proximate to the first location of the electric vehicle.

16. The apparatus of claim 10, wherein the determined dynamic power sharing availability indicator is determined at least in part on real-time data from a charge point operator.

17. The apparatus of claim 10, wherein the determined dynamic power sharing availability indicator is used to route one or more electric vehicles to an electric vehicle charge point.

18. The apparatus of claim 17, wherein the routing data for at least two electric vehicles is used to update a dynamic power sharing availability indicator.

19. The apparatus of claim 10, wherein the determined dynamic power sharing availability indicator is used to initiate an automated vehicle control signal.

20. The apparatus of claim 10, wherein the determined dynamic power sharing availability indicator is used to update routing data for a vehicle.
